(19) United States
(12) Patent Application Publication
(10) Pub. No.: US 2026/0349476 A1
(43) Pub. Date: Nov. 5, 2026

(54) ELECTRONIC DEVICE

(71) Applicant: WNC Corporation, Hsinchu (TW)

(72) Inventors: Chia Yao HSU, Hsinchu (TW); Chia-Hao CHANG, Hsinchu (TW)

(21) Appl. No.: 19/553,517

(22) Filed: Mar. 2, 2026

(30) Foreign Application Priority Data
May 1, 2025 (TW) 114116463

(51) Int. Cl. G06F 1/16; H01Q 1/22

(52) U.S. Cl. CPC G06F 1/1656; H01Q 1/2266

(57) ABSTRACT

An electronic device includes a pivot unit, a first plate, a second plate and an antenna unit. The first plate and the second plate are connected to the pivot unit. The antenna unit is connected to the pivot unit and includes a signal portion, a ground portion and a dielectric portion. The signal portion and the ground portion are connected to the dielectric portion and extend along a surface of the dielectric portion. When the first plate, the second plate and the pivot unit achieve a first usage mode through pivoting and the first plate is parallel to the second plate, the pivot unit and the antenna unit are both located at one end of each of the first plate and the second plate. At least a part of the signal portion and the grounding portion faces centers of the first plate and the second plate.

### RELATED APPLICATIONS

This application claims the benefit of priority to Taiwan Patent Application No. 114116463, filed on May 1, 2025. The entire content of the above identified application is incorporated herein by reference.

### BACKGROUND

### Technical Field

The present disclosure relates to an electronic device, in particular to an electronic device that achieves different usage modes through pivoting.

### Description of Related Art

As technology develops, the requirements of users for functional characteristics and usage modes of electronic devices have become increasingly demanding, thereby increasing the cost and development complexity of electronic devices.

In the current technology, a notebook computer may be in a flippable form, that is, it can be switched between a notebook computer mode and a tablet computer mode through flipping or folding. In addition, besides the requirements for slim dimensions, narrow-bezel screens and wireless communication bandwidth, consumers also have requirements for appearance and texture. Accordingly, conventional plastic materials need to be replaced with metallic materials, which make antenna design more difficult while still satisfying consumer demands.

In view of the above, in the current market of electronic devices, there is an urgent need to develop an electronic device that can simultaneously satisfy slim dimensions, narrow-bezel screens, wireless communication bandwidth and appearance texture, and can reduce the complexity of antenna design.

### SUMMARY

One aspect of the present disclosure is to provide an electronic device including a pivot unit, a first plate, a second plate and an antenna unit. The first plate is connected to the pivot unit. The second plate is connected to the pivot unit. The antenna unit is connected to the pivot unit and includes a signal portion, a ground portion and a dielectric portion. The signal portion and the ground portion are connected to the dielectric portion, and the signal portion and the ground portion extend along a surface of the dielectric portion. When the first plate, the second plate and the pivot unit achieve a first usage mode through pivoting and the first plate is parallel to the second plate, the pivot unit and the antenna unit are both located at one end of each of the first plate and the second plate, and at least a part of the signal portion and the ground portion faces a center of the first plate and a center of the second plate.

Another aspect of the present disclosure is to provide an electronic device including a pivot unit, a first plate, a second plate and an antenna unit. The first plate is connected to the pivot unit and includes a first surface and a second surface. The second plate is connected to the pivot unit and includes a third surface and a fourth surface. The antenna unit is connected to the pivot unit and includes a signal portion, a ground portion and a dielectric portion. The signal portion and the ground portion are connected to the dielectric portion, and the signal portion and the ground portion extend along a surface of the dielectric portion. When the first plate, the second plate and the pivot unit achieve a first usage mode through pivoting, the first surface and the fourth surface serve as two inward surfaces of the electronic device and form a first included angle, the second surface and the third surface serve as two outward surfaces of the electronic device and form a second included angle, the first included angle is smaller than the second included angle, and at least half of the signal portion and at least half of the ground portion face an inner side sandwiched between the first plate and the second plate.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional view of an electronic device according to an example of an embodiment of the present disclosure in a first usage mode.

FIG. 2 is a partial exploded view of the electronic device in FIG. 1.

FIG. 3 is a side view of the electronic device in FIG. 1.

FIG. 4 is a three-dimensional view of the electronic device in FIG. 1 in a second usage mode.

FIG. 5 is a partial exploded view of the electronic device in FIG. 4.

FIG. 6 is a three-dimensional view of an antenna unit of the electronic device in FIG. 5.

FIG. 7 is a three-dimensional view of a signal portion and a ground portion of the antenna unit in FIG. 6.

FIG. 8 is a schematic diagram of Voltage Standing Wave Ratio (VSWR) of the electronic device in FIG. 1 in the first usage mode.

FIG. 9 is a schematic diagram of VSWR of the electronic device in FIG. 1 in the second usage mode.

FIG. 10 is a schematic diagram of antenna efficiency of the electronic device in FIG. 1 in the first usage mode and the second usage mode.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

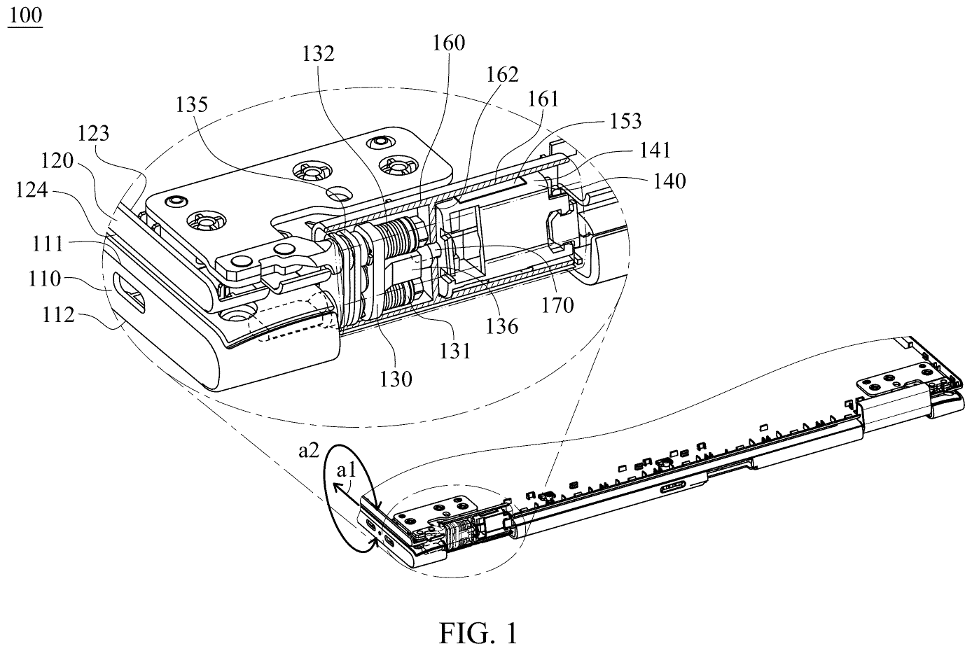

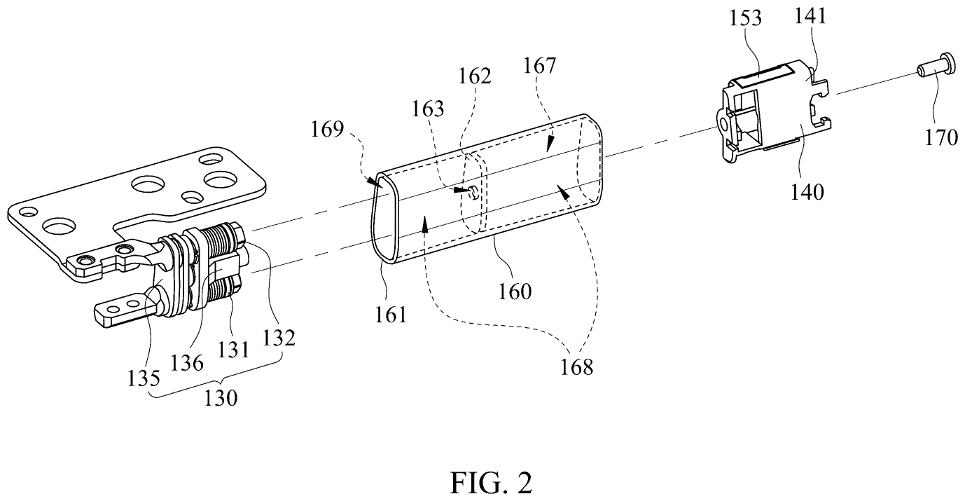

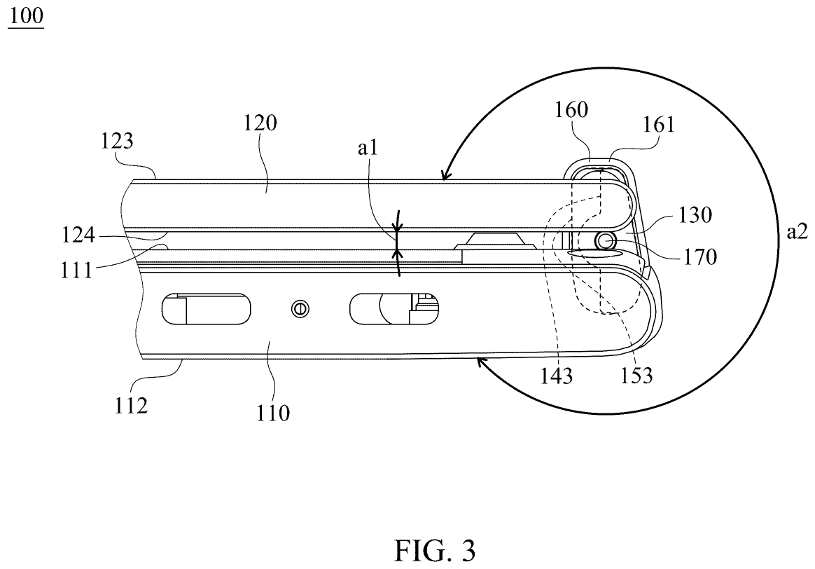

FIG. 1 is a three-dimensional view of an electronic device 100 according to an example of an embodiment of the present disclosure in a first usage mode. FIG. 2 is a partial exploded view of the electronic device 100 in FIG. 1. FIG. 3 is a side view of the electronic device 100 in FIG. 1. Referring to FIGS. 1 to 3, the electronic device 100 includes a pivot unit 130, a first plate 110, a second plate 120 and an antenna unit 140. The first plate 110 is connected to the pivot unit 130, and the second plate 120 is connected to the pivot unit 130. In addition, at least one of the pivot unit 130, the first plate 110, the second plate 120 and other elements adjacent to the antenna unit 140 may be made of a metallic material, or may be formed of a non-metallic material with a metallic surface film layer formed by coating or plating, and the present disclosure is not limited thereto.

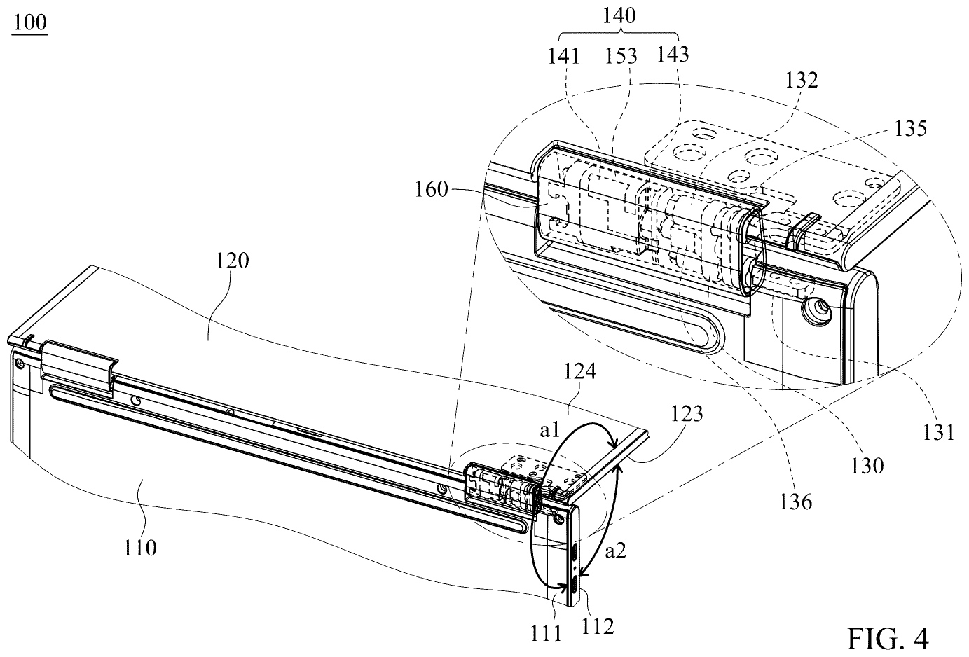

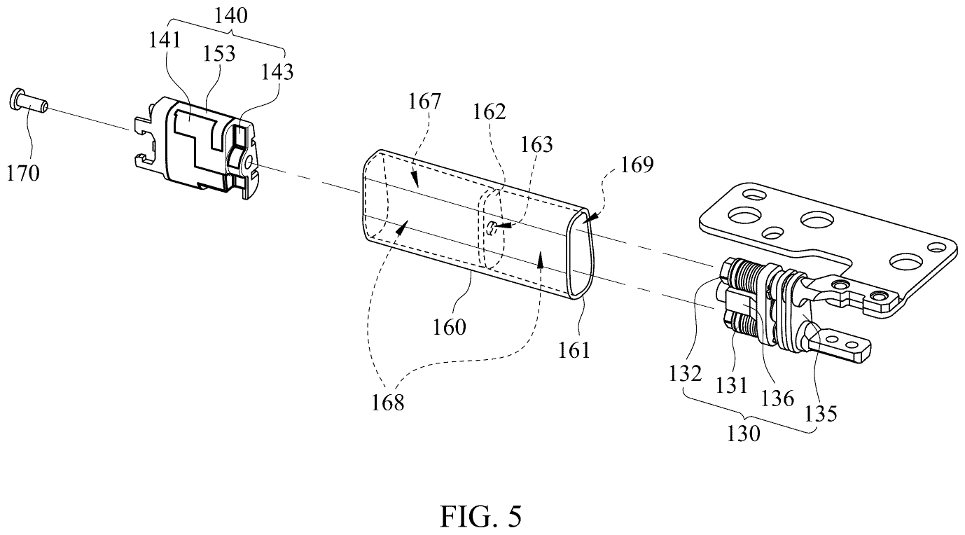

FIG. 4 is a three-dimensional view of the electronic device 100 in FIG. 1 in a second usage mode. FIG. 5 is a partial exploded view of the electronic device 100 in FIG. 4. Referring to FIGS. 4 and 5, the antenna unit 140 is connected to the pivot unit 130. The antenna unit 140 includes a signal portion 143, a ground portion 153 and a dielectric portion 141. The signal portion 143 and the ground portion 153 are separated from each other and are connected to the dielectric portion 141, and the signal portion 143 and the ground portion 153 extend along a surface of the dielectric portion 141.

Referring to FIGS. 1 and 3, when the first plate 110, the second plate 120 and the pivot unit 130 achieve the first usage mode through pivoting and the first plate 110 is substantially parallel to the second plate 120, the pivot unit 130 and the antenna unit 140 are both located at one end of each of the first plate 110 and the second plate 120, and at least a part of the signal portion 143 and the ground portion 153 faces (is oriented toward) a center of the first plate 110 and a center of the second plate 120 (that is, a plate center or an inner side of the plate). It may also be said that, in the first usage mode of the electronic device 100, the at least part of the signal portion 143 and the ground portion 153 faces an inner side sandwiched between the first plate 110 and the second plate 120. Thus, this helps reduce the complexity of antenna design when the electronic device 100 serves as a foldable electronic device, and enables the electronic device 100 to satisfy SAR (Specific Absorption Rate) test requirements.

Furthermore, when the first plate 110, the second plate 120 and the pivot unit 130 achieve the first usage mode through pivoting and the first plate 110 is parallel to the second plate 120, at least half of the signal portion 143 and at least half of the ground portion 153 may face the center of the first plate 110 and the center of the second plate 120. Therefore, SAR test requirements can be satisfied to an even greater extent.

Referring to FIGS. 1 to 5, the electronic device 100 may be a foldable/flippable/deformable electronic device. The first usage mode is a tablet computer mode (as shown in FIGS. 1 to 3), and a second usage mode achieved by pivoting the first plate 110, the second plate 120 and the pivot unit 130 is a notebook computer mode (as shown in FIGS. 4 and 5). Thus, as the required operating bands of modern electronic devices have increased from Wi-Fi (2.4 GHz/5 GHZ) to Wi-Fi 6E, antenna design has become more difficult, while the electronic device 100 according to the present disclosure helps maintain good antenna characteristics in both the tablet computer mode and the notebook computer mode under a metallic environment.

Moreover, in an example of another embodiment of the present disclosure, the electronic device 100 includes the pivot unit 130, the first plate 110, the second plate 120 and the antenna unit 140. The first plate 110 is connected to the pivot unit 130 and includes a first surface 111 and a second surface 112. The second plate 120 is connected to the pivot unit 130 and includes a third surface 123 and a fourth surface 124. The antenna unit 140 is connected to the pivot unit 130 and includes the signal portion 143, the ground portion 153 and the dielectric portion 141. The signal portion 143 and the ground portion 153 are connected to the dielectric portion 141, and the signal portion 143 and the ground portion 153 extend along a surface of the dielectric portion 141. In addition, in FIG. 1, a part of the third surface 123 is removed so as to more clearly show the pivot unit 130 and other elements.

Referring to FIGS. 1 to 3, when the first plate 110, the second plate 120 and the pivot unit 130 achieve the first usage mode through pivoting, the first surface 111 and the fourth surface 124 serve as two inward surfaces of the electronic device 100 and form a first included angle a1, and the second surface 112 and the third surface 123 serve as two outward surfaces of the electronic device 100 and form a second included angle a2, and the first included angle a1 is smaller than the second included angle a2. As shown in FIGS. 1 and 3, in the first usage mode, the first included angle a1 is an inner angle formed by the first plate 110 and the second plate 120, and the second included angle a2 is an outer angle formed by the first plate 110 and the second plate 120. Furthermore, at least half of the signal portion 143 and at least half of the ground portion 153 face an inner side sandwiched between the first plate 110 and the second plate 120. In addition, a screen (not shown in the drawings) may be located on the second surface 112 or the third surface 123. In this embodiment, the screen is specifically located on the third surface 123. Thus, when the electronic device 100 is in the first usage mode (the tablet computer mode), the user faces the screen located on an outer side sandwiched between the first plate 110 and the second plate 120, while a main part of the signal portion 143 and a main part of the ground portion 153 face the inner side sandwiched between the first plate 110 and the second plate 120 (as shown in FIG. 3). Therefore, this helps the electronic device 100 satisfy SAR test requirements in the first usage mode. In addition, it should be noted that, according to design specifications and usage requirements of the electronic device 100, when the electronic device 100 is in the first usage mode, the first plate 110 may be substantially parallel to the second plate 120 (that is, the first included angle a1 is 0 degrees and the second included angle a2 is 360 degrees, as shown in FIGS. 1 and 3), or the first plate 110 may be substantially not completely parallel to the second plate 120 (for example, the first included angle a1 is greater than 0 degrees and the second included angle a2 is smaller than 360 degrees), as long as the first included angle a1 is smaller than the second included angle a2.

Furthermore, referring to FIGS. 4 and 5, when the first plate 110, the second plate 120 and the pivot unit 130 achieve the second usage mode through pivoting, the first surface 111 and the fourth surface 124 may serve as two outward surfaces of the electronic device 100 and form the first included angle a1, the second surface 112 and the third surface 123 may serve as two inward surfaces of the electronic device 100 and form the second included angle a2, and the first included angle a1 is greater than the second included angle a2. As shown in FIG. 4, in the second usage mode, the first included angle a1 is an outer angle formed by the first plate 110 and the second plate 120, and the second included angle a2 is an inner angle formed by the first plate 110 and the second plate 120. Furthermore, at least half of the signal portion 143 and at least half of the ground portion 153 face an outer side sandwiched between the first plate 110 and the second plate 120. Thus, when the electronic device 100 is in the second usage mode (the notebook computer mode), the user faces the screen on the inner side sandwiched between the first plate 110 and the second plate 120, while the main part of the signal portion 143 and the main part of the ground portion 153 face the outer side sandwiched between the first plate 110 and the second plate 120 (as shown in FIG. 4). Therefore, this helps the electronic device 100 satisfy SAR test requirements in the second usage mode.

Referring to FIGS. 1 to 5, the antenna unit 140 may be connected to the pivot unit 130 through a screw 170, and the antenna unit 140 is closer than the pivot unit 130 to the center of the first plate 110 and the center of the second plate 120, that is, the antenna unit 140 is closer than the pivot unit 130 to a pivot center between the first plate 110 and the second plate 120. Thus, this helps satisfy SAR test requirements and pivoting stability

The electronic device 100 may further include an outer cover unit 160 including a cover body 161, a receiving space 167 and two outer cover openings 169. The cover body 161 forms the receiving space 167, and the two outer cover openings 169 respectively allow the antenna unit 140 and the pivot unit 130 to extend into the receiving space 167 so that the antenna unit 140 and the pivot unit 130 are disposed through/inserted in the outer cover unit 160. Thus, the outer cover unit 160 can protect the antenna unit 140 and the pivot unit 130 so as to prevent the antenna unit 140 and the pivot unit 130 from being exposed and to improve appearance, and the outer cover unit 160 may be made of a plastic material and have a metallic surface film layer formed by coating, but the present disclosure is not limited thereto.

The antenna unit 140 may be fixed to the pivot unit 130 through the cover body 161. Accordingly, pivoting stability and smoothness can be improved.

The pivot unit 130 may include a pivot body 135, a first pivot portion 131, a second pivot portion 132 and a mounting portion 136. A part of the first pivot portion 131 is fixed to the first plate 110 and another part thereof is pivotally connected to the pivot body 135. A part of the second pivot portion 132 is fixed to the second plate 120 and another part thereof is pivotally connected to the pivot body 135. The mounting portion 136 is fixed to the pivot body 135. The cover body 161 may further include a penetrating seat 162, and a screw 170 passes through the antenna unit 140, the penetrating seat 162 and the mounting portion 136. Thus, requirements of flipping usage in the first usage mode and the second usage mode and characteristic requirements of the antenna unit 140 can be satisfied.

The penetrating seat 162 may divide the receiving space 167 into two sub-receiving spaces 168 and includes a through opening 163, and the screw 170 passes through the through opening 163. Thus, the antenna unit 140 and the pivot unit 130 can be stably assembled inside the outer cover unit 160.

The first pivot portion 131, the second pivot portion 132 and the mounting portion 136 may be parallel to one another, and the mounting portion 136 is disposed between the first pivot portion 131 and the second pivot portion 132. Therefore, limited space can be effectively utilized while maintaining smooth pivoting.

The antenna unit 140 may be manufactured by Laser Direct Structuring (LDS). Thus, antenna design flexibility can be improved in the limited space of the electronic device 100. In FIG. 5, a length of the antenna unit 140 that is parallel to an axial direction of the screw 170 and does not include a tooth portion on the left side is about 16 mm, and a length of the antenna unit 140 that is perpendicular to the axial direction of the screw 170 is about 14.8 mm.

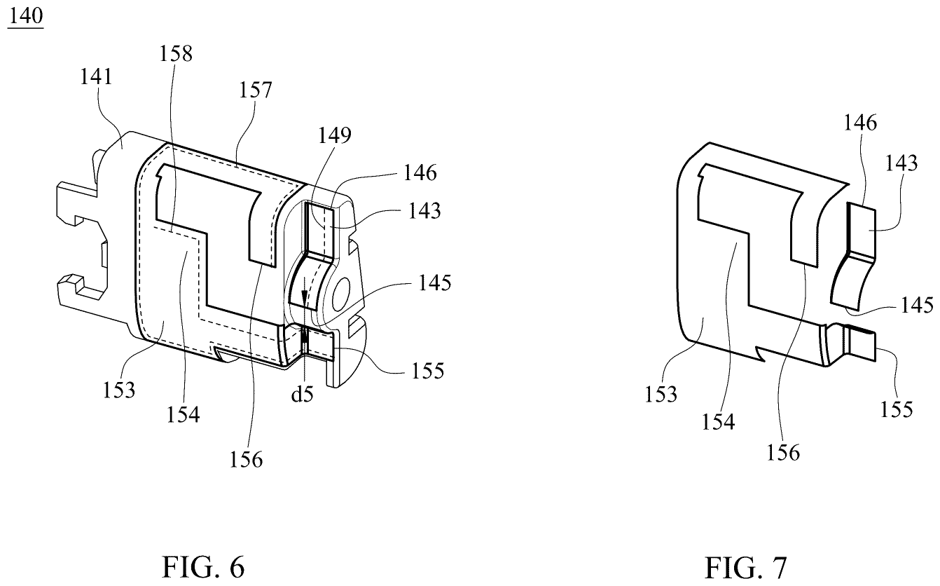

FIG. 6 is a three-dimensional view of the antenna unit 140 of the electronic device 100 in FIG. 5. FIG. 7 is a three-dimensional view of the signal portion 143 and the ground portion 153 of the antenna unit 140 in FIG. 6. Referring to FIGS. 6 and 7, the ground portion 153 may be a floating ground, that is, the ground portion 153 is not in contact with or electrically connected to a system ground of the electronic device 100. The ground portion 153 has a first grounding end 155 and a second grounding end 156, and both the first grounding end 155 and the second grounding end 156 are adjacent to the signal portion 143. Thus, when the deformable electronic device 100 increases antenna operating bands (for example, from Wi-Fi 2.4 GHZ/5 GHz to further include Wi-Fi 6E), under an environment in which metallic parts are disposed around the antenna unit 140, the antenna unit 140 can avoid being integrated with surrounding metal or can reduce its connection range, thereby facilitating smooth flipping of the electronic device 100 when switching between the first usage mode and the second usage mode.

Each of the first grounding end 155 and the second grounding end 156 is an open end, and an area of the ground portion 153 is greater than an area of the signal portion 143. Thus, in addition to having grounding characteristics, the ground portion 153 may also have a potential to increase radiation characteristics.

The ground portion 153 may be configured to provide a first path (resonant path) 157 and a second path 158. The first path 157 and the second path 158 respectively correspond to a first operating frequency and a second operating frequency. A maximum path length of the ground portion 153 is a length of the first path 157, and the length of the first path 157 is greater than a length of the second path 158. Thus, when the ground portion 153 also has radiation characteristics, the larger area characteristic of the ground portion 153 can be advantageously used for responsibility of a lower operating frequency. In this embodiment, the range of the first operating frequency is from 2.4 GHz to 2.5 GHz, and the range of the second operating frequency is from 5.15 GHz to 5.85 GHz. That is, the first operating frequency and the second operating frequency respectively correspond to Wi-Fi 2.4 GHz and Wi-Fi 5 GHZ, and the lengths of the first path 157 and the second path 158 are about one-half of wavelengths respectively corresponding to the first operating frequency and the second operating frequency, and the present disclosure is not limited thereto.

A ratio of the length of the first path 157 to the length of the second path 158 may be between 2.0 and 3.0. Thus, through appropriate shape design of the ground portion 153, the ground portion 153 can simultaneously provide a grounding function and a multi-band radiation function.

The ground portion 153 includes a widened region 154. The first path 157 is from the first grounding end 155 to the second grounding end 156, and the second path 158 is from the first grounding end 155 to the widened region 154. Thus, the widened region 154 helps improve the grounding characteristics of the ground portion 153 and adds, for the antenna unit 140, the second operating frequency corresponding to the second path 158.

The signal portion 143 may have a first signal end 145 and a second signal end 146, and the first signal end 145 is used for providing a feed port (not shown in the drawings). The signal portion 143 may be configured to provide a third path 149, and the third path 149 extends from the first signal end 145 to the second signal end 146. The third path 149 corresponds to a third operating frequency, and the length of the second path 158 is greater than a length of the third path 149. Thus, the antenna unit 140 has a dipole-coupled structure, and the ground portion 153 is the floating ground. A lower operating frequency (for example, Wi-Fi 2.4 GHz/5 GHZ) can be excited through the ground portion 153, and a higher operating frequency (for example, Wi-Fi 6E) can be excited through the signal portion 143 provided with the feed port. This mechanism helps reduce the influence of mechanism when the notebook computer mode is flipped to the tablet computer mode, and maintains good antenna characteristics and reduces an antenna size. In this embodiment, the range of the third operating frequency is from 5.925 GHZ to 7.125 GHz, that is, the third operating frequency corresponds to Wi-Fi 6E, the length of the third path 149 is about one-fourth of a wavelength corresponding to the third operating frequency, and the present disclosure is not limited thereto. In addition, the antenna unit 140 may further include a cable receiving groove (not denoted in the drawings) for positioning a feed cable and electrically connecting the feed port on the signal portion 143.

A distance d5 between the first signal end 145 and the first grounding end 155 along the surface of the dielectric portion 141 may be between 1 mm and 3 mm. Thus, a mode of the third operating frequency can be adjusted by adjusting the distance d5.

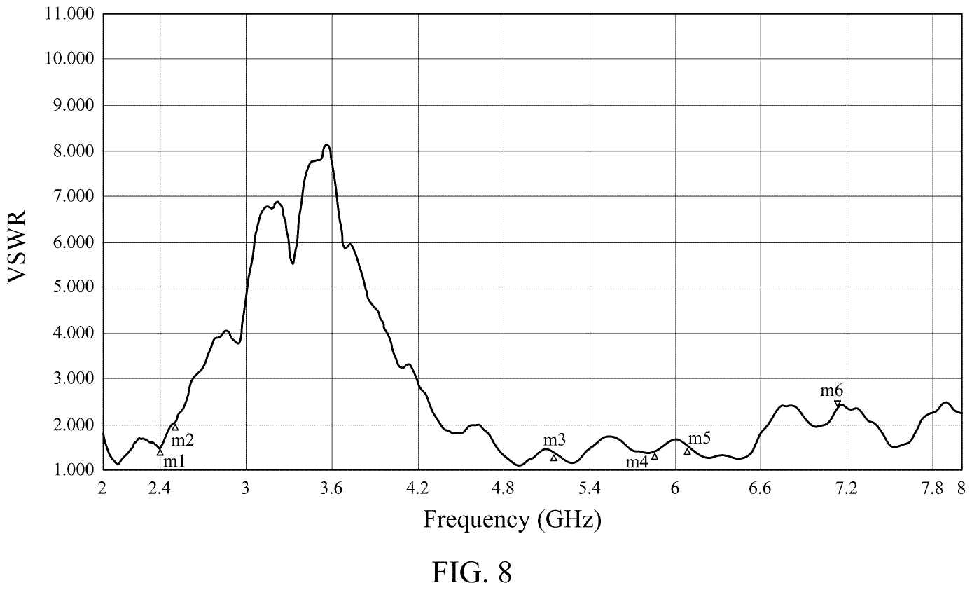

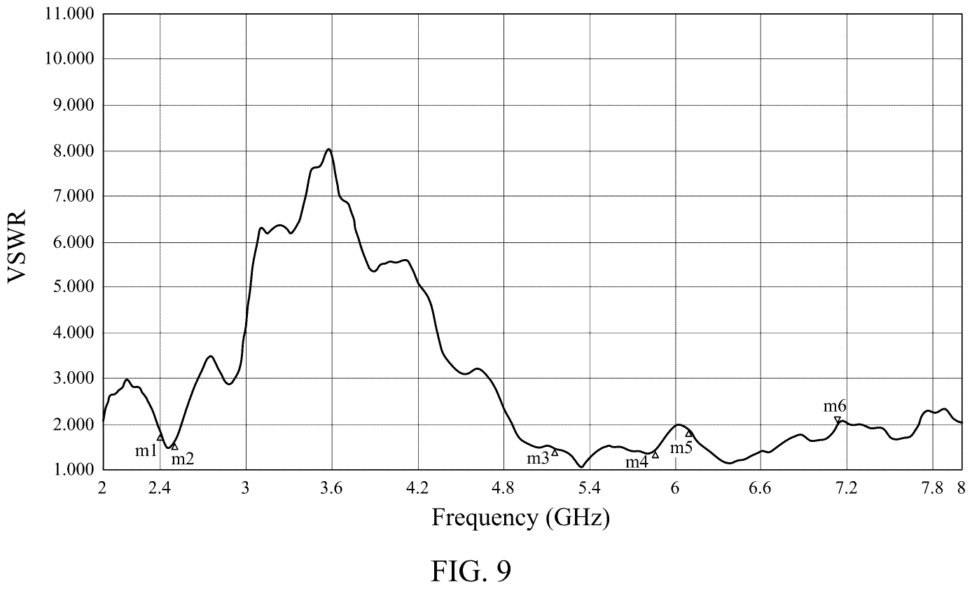

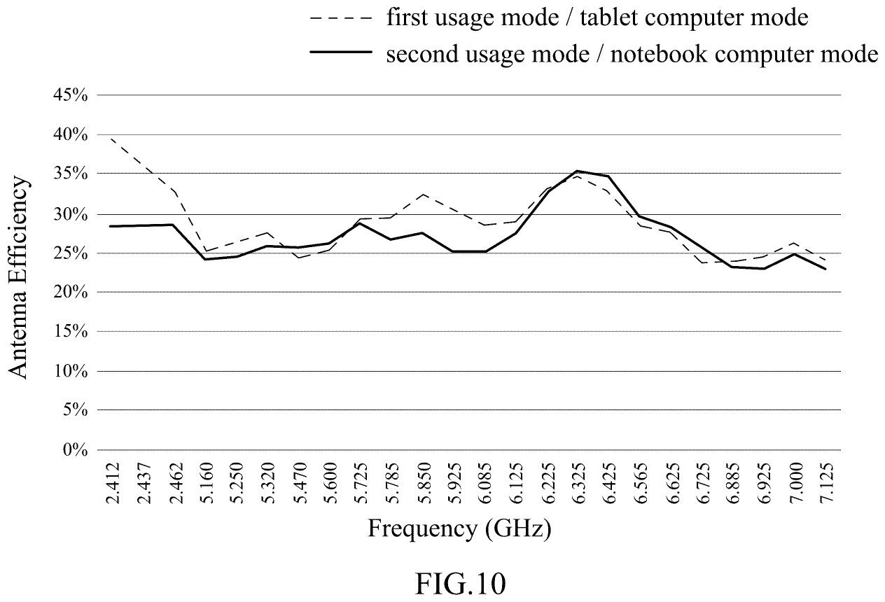

FIG. 8 is a schematic diagram of Voltage Standing Wave Ratio (VSWR) of the electronic device 100 in FIG. 1 in the first usage mode. FIG. 9 is a schematic diagram of VSWR of the electronic device 100 in FIG. 1 in the second usage mode. FIG. 10 is a schematic diagram of antenna efficiency of the electronic device 100 in FIG. 1 in the first usage mode and the second usage mode. Referring to FIGS. 8 to 10 and to data of markers m1, m2, m3, m4, m5, m6 indicated in FIGS. 8 and 9 listed in Table 1 below, the electronic device 100 according to the present disclosure can satisfy antenna characteristic requirements in Wi-Fi 2.4 GHZ, 5 GHZ and Wi-Fi 6E bands in the first usage mode (tablet computer mode corresponding to FIGS. 1 to 3) and the second usage mode (notebook computer mode corresponding to FIGS. 4 and 5), and can further satisfy SAR test requirements.

TABLE 1

VSWR

| | | First usage/ | Second usage/ |
|---|---|---|---|
| | Frequency | tablet computer | notebook computer |
| Marker | (GHz) | mode (FIG. 8) | mode (FIG. 9) |
| m1 | 2.4 | 1.48 | 1.83 |
| m2 | 2.5 | 2.04 | 1.62 |
| m3 | 5.15 | 1.36 | 1.47 |
| m4 | 5.85 | 1.41 | 1.42 |
| m5 | 6.085 | 1.51 | 1.88 |
| m6 | 7.125 | 2.31 | 1.98 |

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electronic device, comprising:
a pivot unit;
a first plate connected to the pivot unit;
a second plate connected to the pivot unit; and
an antenna unit connected to the pivot unit, the antenna unit comprising a signal portion, a ground portion and a dielectric portion, the signal portion and the ground portion being connected to the dielectric portion, and the signal portion and the ground portion extending along a surface of the dielectric portion;
wherein when the first plate, the second plate and the pivot unit achieve a first usage mode through pivoting and the first plate is parallel to the second plate, the pivot unit and the antenna unit are both located at one end of each of the first plate and the second plate, and at least a part of the signal portion and the ground portion faces a center of the first plate and a center of the second plate.

2. The electronic device according to claim 1, wherein the antenna unit is connected to the pivot unit through a screw, and the antenna unit is closer than the pivot unit to the center of the first plate and the center of the second plate.

3. The electronic device according to claim 1, further comprising:
an outer cover unit comprising a cover body, a receiving space and two outer cover openings, wherein the cover body forms the receiving space, and the two outer cover openings respectively allow the antenna unit and the pivot unit to extend into the receiving space so that the antenna unit and the pivot unit are disposed through the outer cover unit.

4. The electronic device according to claim 3, wherein the antenna unit is fixed to the pivot unit through the cover body.

5. The electronic device according to claim 3, wherein the pivot unit comprises a pivot body, a first pivot portion, a second pivot portion and a mounting portion, the first pivot portion being fixed to the first plate and pivotally connected to the pivot body, the second pivot portion being fixed to the second plate and pivotally connected to the pivot body, and the mounting portion being fixed to the pivot body;
wherein the cover body further comprises a penetrating seat, and a screw passes through the antenna unit, the penetrating seat and the mounting portion.

6. The electronic device according to claim 5, wherein the penetrating seat divides the receiving space into two sub-receiving spaces and comprises a through opening, and the screw passes through the through opening.

7. The electronic device according to claim 5, wherein the first pivot portion, the second pivot portion and the mounting portion are parallel to one another, and the mounting portion is disposed between the first pivot portion and the second pivot portion.

8. The electronic device according to claim 1, wherein when the first plate, the second plate and the pivot unit achieve the first usage mode through pivoting and the first plate is parallel to the second plate, at least half of the signal portion and at least half of the ground portion face the center of the first plate and the center of the second plate.

9. The electronic device according to claim 1, wherein the antenna unit is manufactured by Laser Direct Structuring (LDS).

10. The electronic device according to claim 1, wherein the ground portion is a floating ground and has a first grounding end and a second grounding end, and both the first grounding end and the second grounding end are adjacent to the signal portion.

11. The electronic device according to claim 1, wherein the ground portion has a first grounding end and a second grounding end, each of the first grounding end and the second grounding end is an open end, and an area of the ground portion is greater than an area of the signal portion.

12. The electronic device according to claim 1, wherein the ground portion is configured to provide a first path and a second path, the first path and the second path respectively corresponding to a first operating frequency and a second operating frequency, a maximum path length of the ground portion is a length of the first path, and the length of the first path is greater than a length of the second path.

13. The electronic device according to claim 12, wherein a ratio of the length of the first path to the length of the second path is between 2.0 and 3.0.

14. The electronic device according to claim 12, wherein the ground portion has a first grounding end and a second grounding end and comprises a widened region, the first path extends from the first grounding end to the second grounding end, and the second path extends from the first grounding end to the widened region.

15. The electronic device according to claim 14, wherein the signal portion has a first signal end and a second signal end, the first signal end is configured for providing a feed port, and a distance between the first signal end and the first grounding end is between 1 mm and 3 mm.

16. The electronic device according to claim 12, wherein the signal portion is configured to provide a third path, the third path corresponding to a third operating frequency, and the length of the second path is greater than a length of the third path.

17. The electronic device according to claim 1, wherein the electronic device is a foldable electronic device, the first usage mode is a tablet computer mode, and a second usage mode achieved by pivoting the first plate, the second plate and the pivot unit is a notebook computer mode.

18. An electronic device, comprising:
a pivot unit;
a first plate connected to the pivot unit and comprising a first surface and a second surface;
a second plate connected to the pivot unit and comprising a third surface and a fourth surface; and
an antenna unit connected to the pivot unit, the antenna unit comprising a signal portion, a ground portion and a dielectric portion, the signal portion and the ground portion being connected to the dielectric portion, and the signal portion and the ground portion extending along a surface of the dielectric portion;
wherein when the first plate, the second plate and the pivot unit achieve a first usage mode through pivoting, the first surface and the fourth surface serve as two inward surfaces of the electronic device and form a first included angle, the second surface and the third surface serve as two outward surfaces of the electronic device and form a second included angle, the first included angle is smaller than the second included angle, and at least half of the signal portion and at least half of the ground portion face an inner side sandwiched between the first plate and the second plate.

19. The electronic device according to claim 18, wherein when the first plate, the second plate and the pivot unit achieve a second usage mode through pivoting, the first surface and the fourth surface serve as two outward surfaces of the electronic device and form the first included angle, the second surface and the third surface serve as two inward surfaces of the electronic device and form the second included angle, the first included angle is greater than the second included angle, and the at least half of the signal portion and the at least half of the ground portion face an outer side sandwiched between the first plate and the second plate.

20. The electronic device according to claim 19, wherein the electronic device is a foldable electronic device, the first usage mode is a tablet computer mode, the second usage mode is a notebook computer mode, and a screen is located on the second surface or the third surface.
